(19) United States
(12) Patent Application Publication
(10) Pub. No.: US 2017/0050690 A1
(43) Pub. Date: Feb. 23, 2017

(54) TRACK INSTALLATION SYSTEM

(71) Applicant: Caterpillar Inc., Peoria, IL (US)

(72) Inventors: Joshua Adam Mason, Washington, IL (US); Peter Hsien Huang, Edwards, IL (US); Scott A. Kammeyer, Dunlap, IL (US); Timothy Allen Goldammer, Princeville, IL (US); Lon Kenneth Kennelly, Yates City, IL (US)

(73) Assignee: Caterpillar Inc., Peoria, IL (US)

(21) Appl. No.: 15/343,641

(22) Filed: Nov. 4, 2016

(51) Int. Cl. B62D 55/32; G05B 19/402

(52) U.S. Cl. CPC B62D 55/32; G05B 19/402; E02F 3/7604

(57) ABSTRACT

A track installation system for a machine is provided. The track installation system includes an operator interface. The operator interface is configured to provide a signal indicative of an installation of a first track over a first sprocket, and a signal indicative of at least one of a direction and a speed of rotation of the first sprocket. The track installation system also includes a controller configured to receive the signal indicative of the installation of the first track over the first sprocket. The controller is also configured to receive the signal indicative of at least one of the direction and the speed of rotation of the first sprocket. The controller is further configured to control at least a parameter of the machine to hold at least one of the machine, the first sprocket, and the second sprocket in a stationary state.

### TECHNICAL FIELD

The present disclosure relates to a track installation system. More particularly, the present disclosure relates to the track installation system for a tracked machine.

### BACKGROUND

Machine, such as a track type tractor, includes a set of tracks coupled to a frame thereof. The tracks enable movement of the machine on ground. During installation of the track on the machine, an operator may operate one or more controls of the machine including, but not limited to, a steering, a brake, a throttle, and a transmission in order to operate a portion of the machine while holding another portion of the machine and/or the overall machine in a stationary position.

For example, when a right track of the machine may be installed, the operator may control the machine in a manner such that a right sprocket and/or a right side of the transmission of the machine may operate in a selected direction and at a selected speed while maintaining a left sprocket, a left side of the transmission, and/or the overall machine in the stationary position.

Due to complex transmission system design for such machines, the operator may have to operate the various controls simultaneously in order to achieve the required motion of selected portion of the transmission while maintaining the remaining portion of the transmission and/or the overall machine in the stationary position. Based on a skill level of the operator, during the installation process, the machine may tend to move linearly and/or angularly on an assembly line, making installation of the track challenging. Further, the operator may operate the controls of the machine through an operator cabin or while being stationed on any other portion of the machine. This may reduce visibility for the operator around the machine and may also reduce visibility/communication with a ground operator.

U.S. Pat. No. 6,922,881 describes a system and method to install and remove continuous track drive units on vehicles. The system includes two forcing discs connected hydraulically which mimic a shape of end idlers. A hydraulically actuated telescopic separator is positioned between the forcing discs, such that the discs may be separated or brought together. The forcing discs are aligned with the end idlers to allow the continuous track unit to be easily slipped onto the end idlers from the forcing discs. Conversely, when removing continuous track drive units, the forcing discs are again aligned with the end idlers, and the track is slipped off the end idlers and onto the forcing discs.

### SUMMARY OF THE DISCLOSURE

In an aspect of the present disclosure, a track installation system for a machine is provided. The machine includes a first sprocket associated with a first track and a second sprocket associated with a second track. The track installation system includes an operator interface. The operator interface is configured to provide a signal indicative of an installation of the first track over the first sprocket. The operator interface is also configured to provide a signal indicative of at least one of a direction and a speed of rotation of the first sprocket. The track installation system also includes a controller provided in communication with the operator interface. The controller is configured to receive the signal indicative of the installation of the first track over the first sprocket. The controller is also configured to receive the signal indicative of at least one of the direction and the speed of rotation of the first sprocket. The controller is further configured to control at least a parameter of the machine to hold at least one of the machine, the first sprocket, and the second sprocket in a stationary state.

Other features and aspects of this disclosure will be apparent from the following description and the accompanying drawings.

### BRIEF DESCRIPTION OF THE DRAWINGS

FIG. 1 is a side view of an exemplary machine, according to one embodiment of the present disclosure;

FIG. 2 is a schematic representation of a track installation system of the machine of FIG. 1, according to one embodiment of the present disclosure; and

FIG. 3 is a flowchart of working of the track installation system of FIG. 2, according to one embodiment of the present disclosure.

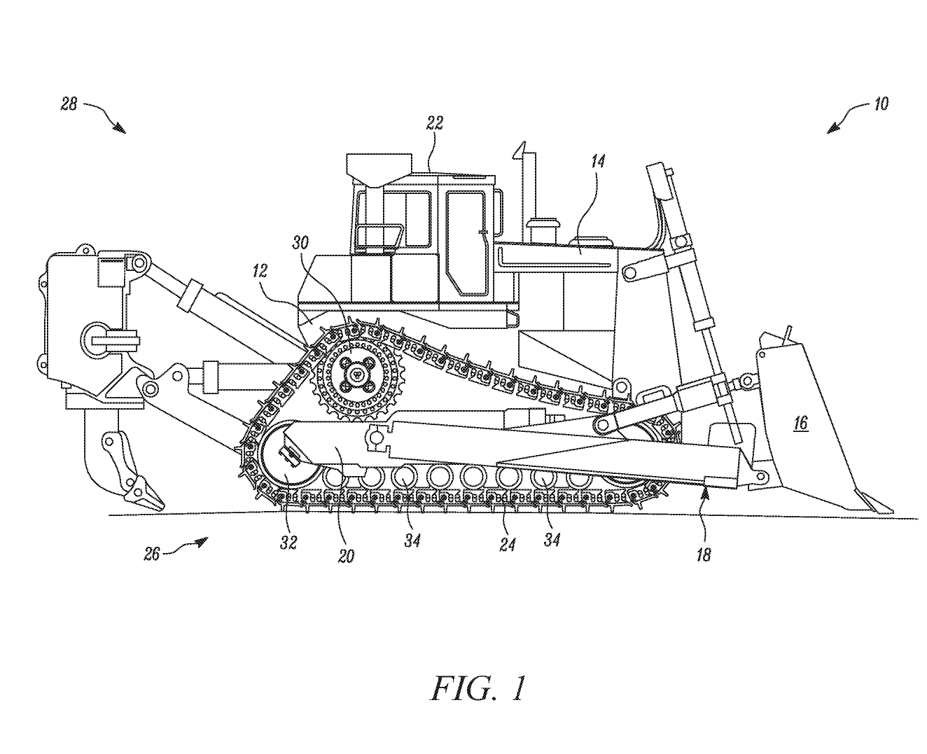

### DETAILED DESCRIPTION

Wherever possible, the same reference numbers will be used throughout the drawings to refer to the same or the like parts. Referring to FIG. 1, an exemplary machine 10 is illustrated. More specifically, the machine 10 is a track type tractor. The machine 10 is associated with an industry such as construction, mining, agriculture, material handling, and so on. The machine 10 may perform tasks including, but not limited, earth moving, demolishment, and so on.

The machine 10 includes a frame 12. The frame 12 supports one or more components of the machine 10. The machine 10 includes an enclosure 14 provided on the frame 12. The enclosure 14 encloses a power source (not shown) mounted on the frame 12. The power source may be any power source known in the art such as an internal combustion engine, batteries, motor, and so on, or a combination thereof. The power source may provide power to the machine 10 for mobility and operational requirements.

The machine 10 includes an implement such as a blade 16. The blade 16 may perform tasks such as earth moving, demolishment, and so on based on application requirements. The machine 10 also includes an arm assembly 18. The arm assembly 18 mounts the blade 16 to the frame 12 of the machine 10. More specifically, the arm assembly 18 movably couples the blade 16 to a first track roller frame 20 of the machine 10. The arm assembly 18 is adapted to vary a distance of the blade 16 with respect to ground based on operational requirements.

The machine 10 includes an operator cabin 22 mounted on the frame 12. The operator cabin 22 may house various controls (not shown) of the machine 10. The controls may include a steering, a control console, joysticks, levers, pedals, switches, knobs, buttons, audio visual devices, and so on. The controls may enable an operator (not shown) to control the machine 10 on the ground. The machine 10 also includes a first track 24 and a second track (not shown) provided on a first side 26 and a second side 28 of the machine 10 respectively.

The first track 24 is mounted to the frame 12 via one or more components such as the first track roller frame 20, a first sprocket 30, first driven wheels 32, first auxiliary wheels 34, and so on. Similarly, the second track is mounted to the frame 12 via one or more components (not shown) such as a second track roller frame, a second sprocket, second driven wheels, second auxiliary wheels, and so on. The first track 24 and the second track support and provide mobility to the machine 10 on the ground.

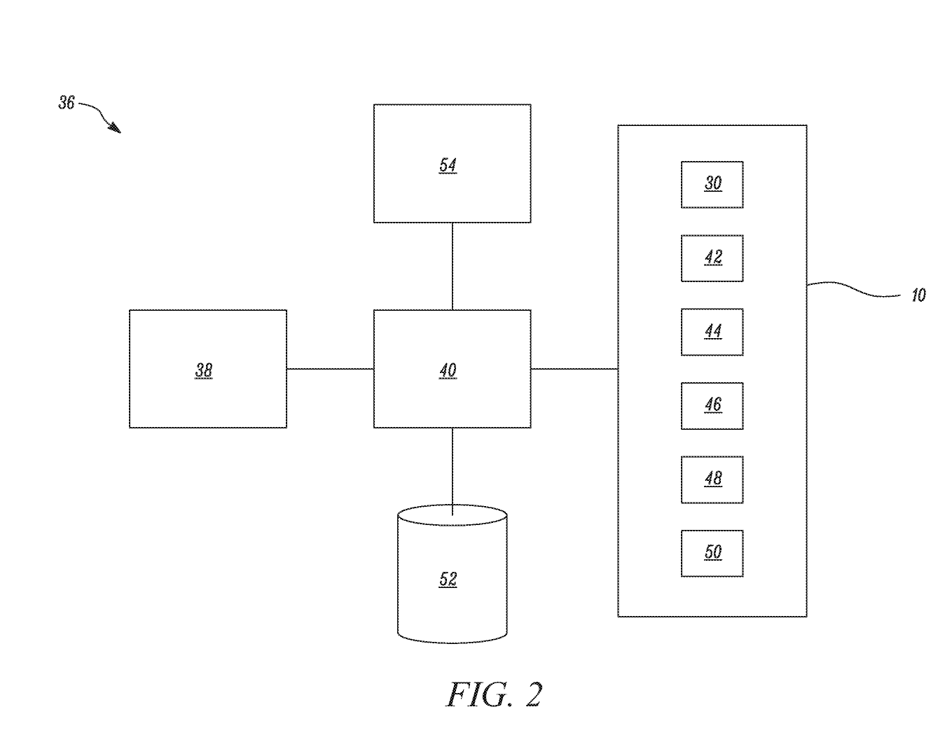

Referring to FIG. 2, a schematic representation of a track installation system 36 is illustrated. The track installation system 36 includes an operator interface 38. In the illustrated embodiment, the operator interface 38 is a display unit (not shown) provided within the operator cabin 22. Alternatively, the display unit may be provided away from the operator cabin 22 such as on an assembly line. The display unit may be any display unit known in the art including, but not limited to an LCD unit, an LED unit, and a touchscreen unit.

In other embodiments, the operator interface 38 may include the various cabin controls provided within the operator cabin 22 such as the joystick, the lever, the pedal, the switch, the knob, and so on. In other embodiments, the operator interface 38 may include a combination of the display unit and the various cabin controls. In yet other embodiments, the operator interface 38 may be a service tool interface, a service computer, a production tester, and so on.

For the purpose of explanation, the track installation system 36 will now be explained with reference to an installation of the first track 24 over the first sprocket 30. It should be noted that the track installation system 36 and a method of operation thereof is similarly applicable for the installation of the second track over the second sprocket. The operator interface 38 is configured to provide a signal indicative of the installation of the first track 24 over the first sprocket 30. More specifically, the operator operates the operator interface 38, such as the display unit and/or the various cabin controls, in order to provide the signal indicative of initiation of the installation of the first track 24 over the first sprocket 30.

Further, the operator interface 38 is configured to provide a signal indicative of a direction of rotation of the first sprocket 30. Additionally, the operator interface 38 is also configured to provide a signal indicative of a speed of rotation of the first sprocket 30. More specifically, the operator operates the operator interface 38 to provide the signal indicative of the direction of rotation, such as clockwise or anti clockwise, of the first sprocket 30. Also, the operator operates the operator interface 38 to provide the signal indicative of the speed of rotation of the first sprocket 30 in the selected direction of rotation thereof.

The track installation system 36 also includes a controller 40. The controller 40 is communicably coupled to the operator interface 38. Accordingly, the controller 40 is configured to receive the signal indicative of initiation of the installation of the first track 24 over the first sprocket 30 from the operator interface 38. The controller 40 is also configured to receive the signal indicative of the direction of rotation of the first sprocket 30 from the operator interface 38. Additionally, the controller 40 is configured to receive the signal indicative of the speed of rotation of the first sprocket 30 from the operator interface 38.

Based on the received signals, the controller 40 is configured to control a parameter of the machine 10 in order to hold the machine 10, the first sprocket 30, and/or the second sprocket 42 in a stationary state. The parameter of the machine 10 includes, but not limited to, the second sprocket 42, the steering 44, a throttle 46, a brake 48, a transmission 50, or a combination thereof. It should be noted that in some embodiments, the machine 10 may include a propulsion system (not shown) other than the transmission 50. In such a situation, the parameter of the machine 10 may include the respective propulsion system.

In one situation, the controller 40 controls an operation of the second sprocket 42, such as a direction and/or a speed of rotation thereof, in order to hold the machine 10, the first sprocket 30, and/or the second sprocket 42 in the stationary state. In another situation, the controller 40 controls an operation of the steering 44 of the machine 10, such as a direction and/or an angle thereof, in order to hold the machine 10, the first sprocket 30, and/or the second sprocket 42 in the stationary state. In another situation, the controller 40 controls an operation of the throttle 46 of the machine 10, such as an idle position, an amount of an acceleration, and so on, in order to hold the machine 10, the first sprocket 30, and/or the second sprocket 42 in the stationary state. In another situation, the controller 40 controls an operation of the brake 48 of the machine 10, such as an amount of a braking torque, a braking bias, and so on, in order to hold the machine 10, the first sprocket 30, and/or the second sprocket 42 in the stationary state.

In another situation, the controller 40 controls an operation of the transmission 50 or the propulsion system of the machine 10, such as a forward position, a reverse position, a neutral position, a gear ratio, and so on thereof, in order to hold the machine 10, the first sprocket 30, and/or the second sprocket 42 in the stationary state. In yet another situation, the controller 40 controls the combined operation of any of the second sprocket 42, the steering 44, the throttle 46, the brake 48, and the transmission 50, in order to hold the machine 10, the first sprocket 30, and/or the second sprocket 42 in the stationary state.

The controller 40 is configured to control the operation of the second sprocket 42, the steering 44, the throttle 46, the brake 48, the transmission 50, or the combination thereof, in order to hold the machine 10, the first sprocket 30, and/or the second sprocket 42 in the stationary state, based on a dataset. The dataset may be stored in a database 52 communicably coupled to the controller 40 or a memory (not shown) of the controller 40.

The dataset may include various values related to the operation of the second sprocket 42, the steering 44, the throttle 46, the brake 48, and the transmission 50 or the propulsion system for different values of the direction and the speed of rotation of the first sprocket 30 in order to hold the machine 10, the first sprocket 30, and/or the second sprocket 42 in the stationary state. In other embodiments, the dataset may include a mathematical expression between the operational values of the second sprocket 42, the steering 44, the throttle 46, the brake 48, and the transmission 50 or the propulsion system, and the direction and the speed of rotation of the first sprocket 30 in order to hold the machine 10, the first sprocket 30, and/or the second sprocket 42 in the stationary state.

Additionally, the controller 40 is configured to monitor a status of the throttle 46, the brake 48, the steering 44, and the transmission 50 of the machine 10, or a combination thereof based on the received signal indicative of the initiation of the installation of the first track 24. More specifically, in one situation, the controller 40 monitors the status of the steering 44 of the machine 10, such as the direction and/or the angle thereof, in order to proceed with the installation process of the first track 24.

In another situation, the controller 40 monitors the status of the throttle 46 of the machine 10, such as the idle position, the amount of the acceleration, and so on, in order to proceed with the installation process of the first track 24. In another situation, the controller 40 monitors the status of the brake 48 of the machine 10, such as the amount of the braking torque, the braking bias, and so on, in order to proceed with the installation process of the first track 24.

In another situation, the controller 40 monitors the status of the transmission 50 of the machine 10, such as the forward position, the reverse position, the neutral position, the gear ratio, and so on thereof, in order to proceed with the installation process of the first track 24. In yet another situation, the controller 40 monitors the combined statuses of any of the steering 44, the throttle 46, the brake 48, and the transmission 50, in order to proceed with the installation process of the first track 24. In a situation when the status of any one of the throttle 46, the brake 48, the steering 44, and the transmission 50 of the machine 10 may be outside an acceptable threshold, the controller 40 is configured to terminate the initiation of the installation process of the first track 24.

The controller 40 may determine the acceptable thresholds, for initiation of the installation process, of the throttle 46, the brake 48, the steering 44, and the transmission 50 of the machine 10 from a dataset stored in the database 52 or the memory of the controller 40. The dataset may include values of the acceptable thresholds of the throttle 46, the brake 48, the steering 44, and the transmission 50 of the machine 10 in order to proceed with the installation process of the first track 24.

Similarly, during the installation process of the first track 24 over the first sprocket 30, the controller 40 is configured to monitor the status of the throttle 46, the brake 48, the steering 44, and the transmission 50 of the machine 10, or a combination thereof. In a situation when the status of any one of the throttle 46, the brake 48, the steering 44, and the transmission 50 of the machine 10 may be outside an acceptable threshold, the controller 40 is configured to terminate the progress of the installation process of the first track 24.

The controller 40 may determine the acceptable thresholds, for progressing with the installation process, of the throttle 46, the brake 48, the steering 44, and the transmission 50 of the machine 10 from a dataset stored in the database 52 or the memory of the controller 40. The dataset may include values of the acceptable thresholds of the throttle 46, the brake 48, the steering 44, and the transmission 50 of the machine 10 in order to proceed with the installation process of the first track 24.

The controller 40 is also configured to receive a signal indicative of termination of the installation of the first track 24 over the first sprocket 30 from the operator interface 38. More specifically, the signal indicative of termination of the installation of the first track 24 may be a predetermined position of the brake 48, a predetermined position of the transmission 50, and so on or any other input through the operator interface 38. Based on the received signal, the controller 40 is configured to terminate the installation of the first track 24. More specifically, the controller 40 halts the installation process and transfers the machine 10 from a track installation mode to a normal operating mode.

Additionally, the controller 40 is configured to receive a signal indicative of a surrounding view of the machine 10 from an image processing device 54. More specifically, in one embodiment, the image processing device 54 may be a rear view camera associated with the machine 10. Accordingly, the rear view camera may provide a signal indicative of a rear view of the machine 10 to the controller 40. In another embodiment, the image processing device 54 may be a side view camera associated with the machine 10. Accordingly, the side view camera may provide a signal indicative of a side view of the machine 10 to the controller 40.

In another embodiment, the image processing device 54 may be a bird's eye view camera associated with the machine 10. Accordingly, the bird's eye view camera may provide a signal indicative of a top view of the machine 10 to the controller 40. In another embodiment, the image processing device 54 may be an external camera associated with the assembly line. Accordingly, the external camera may provide a signal indicative of a surrounding view of the machine 10 to the controller 40 based on a position of the external camera with respect to the machine 10.

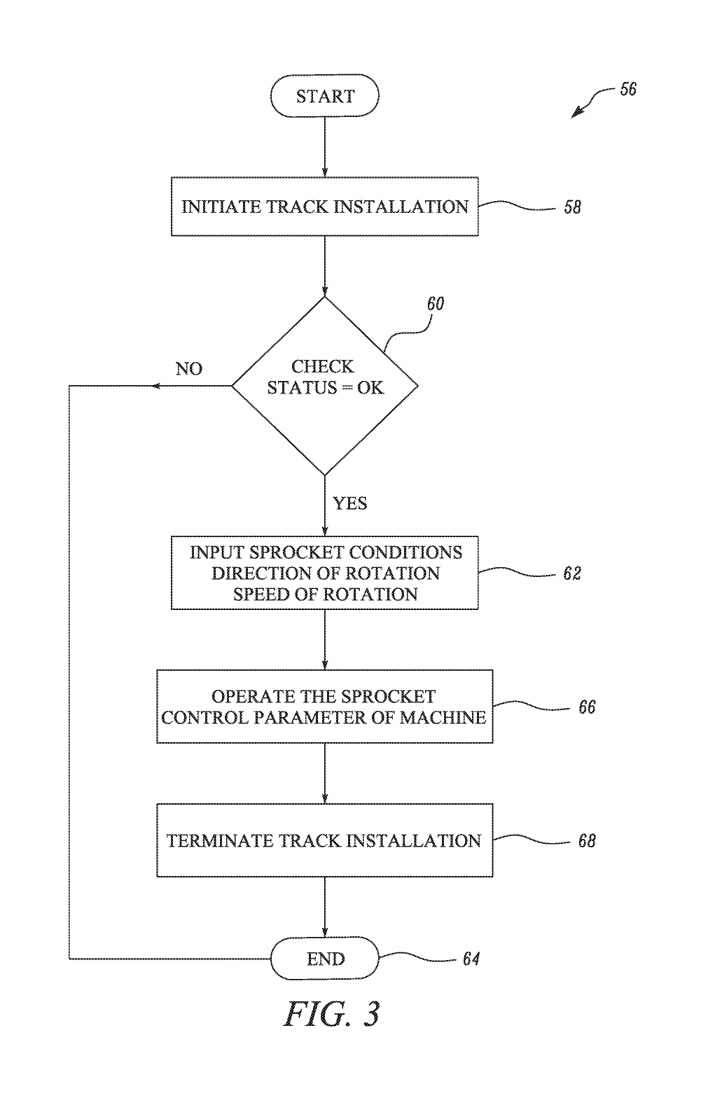

In yet another embodiment, the image processing device 54 may be a combination of different cameras associated with the machine 10 and/or the assembly line. Accordingly, the different cameras may provide a signal indicative of the surrounding view of the machine 10 to the controller 40. Based on the received signal from the image processing device 54, the controller 40 is configured to display the surrounding view of the machine 10 through the operator interface 38. More specifically, the controller 40 displays the surrounding view of the machine 10 on the display unit in order to enable the operator to visually monitor the progress of the installation of the first track 24. The track installation system 36 will be explained in more detail with reference to FIG. 3.

### INDUSTRIAL APPLICABILITY

Referring to FIG. 3, a method 56 of working of the track installation system 36 is illustrated. At step 58, the controller 40 receives the signal indicative of initiation of the installation of the track of the machine 10 over the sprocket. For the purpose of explanation, the method 56 will be explained with reference to the installation of the first track 24 over the first sprocket 30. It should be noted that the method 56 is similarly applicable for the installation of the second track over the second sprocket 42. Accordingly, at step 58, the controller 40 receives the signal indicative of initiation of the installation of the first track 24 over the first sprocket 30 from the operator interface 38.

At step 60, the controller 40 monitors the status of the throttle 46, the brake 48, the steering 44, or the transmission 50 of the machine 10, or the combination thereof. In a situation when the controller 40 determines the status of the throttle 46, the brake 48, the steering 44, and/or the transmission 50 within the threshold, the controller 40 proceeds to step 62. In a situation when the controller 40 determines the status of the throttle 46, the brake 48, the steering 44, and/or the transmission 50 outside the threshold, the controller 40 proceeds to step 64 in order to terminate the track installation process. The controller 40 determines the threshold values from the dataset stored in the database 52 or the memory of the controller 40.

At step 62, the controller 40 receives the signal indicative of the direction of rotation of the first sprocket 30 from the operator interface 38. Additionally, the controller 40 also receives the signal indicative of the speed of rotation of the first sprocket 30 from the operator interface 38. Based on the received signals, the controller 40 proceeds to step 66.

At step 66, the controller 40 operates the first sprocket 30 based on the signals received at step 62. Simultaneously, at step 66, the controller 40 controls the parameter of the machine 10 to hold the machine 10, the first sprocket 30, and/or the second sprocket 42 in a stationary state. The parameter of the machine 10 includes any one or a combination of the operation of the second sprocket 42, the steering 44, the throttle 46, the brake 48, and the transmission 50. The controller 40 controls the parameter of the machine 10 based on the dataset stored in the database 52 or the memory of the controller 40.

In one situation, the controller 40 may control the one or more parameters of the machine 10 in order to hold the machine 10, the first sprocket 30, and the second sprocket 42 in the stationary state. In another situation, the controller 40 may control the one or more parameters of the machine 10 in order to hold the machine 10 and the first sprocket 30 in the stationary state while controlling the rotation of the second sprocket 42 in a predetermined direction and at a predetermined speed. In yet another situation, the controller 40 may control the one or more parameters of the machine 10 in order to hold the machine 10 and the second sprocket 42 in the stationary state while controlling the rotation of the first sprocket 30 in a predetermined direction and at a predetermined speed.

It should be noted that the controller 40 continues to monitor the status of the throttle 46, the brake 48, the steering 44, and/or the transmission 50 of the machine 10 during step 66. As such, in a situation when the status may be within the threshold, the controller 40 continues to operate the first sprocket 30 and control the parameter of the machine 10 to hold the machine 10, the first sprocket 30, and/or the second sprocket 42 in the stationary state. Further, in a situation when the status may be outside the threshold, the controller 40 proceeds to step 64 in order to terminate the track installation process.

At step 68, the controller 40 receives the signal indicative of termination of the installation of the first track 24 over the first sprocket 30 from the operator interface 38. Based on the received signal, the controller 40 proceeds to step 64 in order to terminate the track installation process. Additionally, during the installation process, the controller 40 also receives the signal indicative of the surrounding view of the machine 10 from the image processing device 54. Based on the received signal, the controller 40 displays the surrounding view of the machine 10 to the operator through the operator interface 38.

The track installation system 36 provides a simple, cost effective, and time efficient method for installation of the track on the sprocket of the machine 10. Also, the track installation system 36 provides to control the machine 10 in the stationary state while operating the required sprocket thus reducing operator effort to operate the various machine controls in order to maintain the machine 10 in the required operative state during the track installation process. Further, the track installation system 36 provides the surrounding view of the machine 10 to the operator in turn improving visibility and safety during in the track installation process. Also, the track installation system 36 may be installed on any tracked machine with minor or no modification to the overall machine system.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof.

What is claimed is:

1. A track installation system for a machine, the machine having a first sprocket associated with a first track and a second sprocket associated with a second track, the track installation system comprising:
an operator interface configured to:
provide a signal indicative of an installation of the first track over the first sprocket; and
provide a signal indicative of at least one of a direction and a speed of rotation of the first sprocket; and
a controller provided in communication with the operator interface, the controller configured to:
receive the signal indicative of the installation of the first track over the first sprocket;
receive the signal indicative of at least one of the direction and the speed of rotation of the first sprocket; and
control at least a parameter of the machine to hold at least one of the machine, the first sprocket, and the second sprocket in a stationary state.

2. The track installation system of claim 1, wherein the parameter of the machine includes at least one of the second sprocket, a steering, a throttle, a brake, and a transmission.

3. The track installation system of claim 1, wherein the controller is configured to monitor a status of at least one of a throttle, a brake, a steering, and a transmission of the machine based on the received signal indicative of the installation of the first track.

4. The track installation system of claim 3, wherein the controller is configured to:
terminate the installation of the first track based, at least in part, on the monitoring.

5. The track installation system of claim 1, wherein the controller is configured to:
receive a signal indicative of termination of the installation of the first track over the first sprocket from the operator interface; and
terminate the installation of the first track based, at least in part, on the received signal.

6. The track installation system of claim 1, wherein the controller is configured to:
receive a signal indicative of a surrounding view of the machine from an image processing device; and
display the surrounding view of the machine through the operator interface.
